(19) United States
(12) Patent Application Publication
(10) Pub. No.: US 2026/0153336 A1
(43) Pub. Date: Jun. 4, 2026

(54) DISPLAY SYSTEM

(71) Applicant: TOYOTA JIDOSHA KABUSHIKI KAISHA, Aichi-ken (JP)

(72) Inventors: Suomi TANISHIGE, Tokyo-to (JP); Guanyu WANG, Tokyo-to (JP); Antoine RIOUX, Tokyo-to (JP)

(73) Assignee: TOYOTA JIDOSHA KABUSHIKI KAISHA, Aichi-ken (JP)

(21) Appl. No.: 19/379,749

(22) Filed: Nov. 5, 2025

(30) Foreign Application Priority Data
Nov. 29, 2024 (JP) 2024-207972

(51) Int. Cl. G01C 21/20

(52) U.S. Cl. CPC G01C 21/206

(57) ABSTRACT

A display system according to the present disclosure displays routes connecting a plurality of locations. The display system includes a storage unit configured to store at least one of location information on the number of the moving bodies accommodable at each location and route information on a width of each route, and a determination unit configured to determine: a display mode of a route starting from a first location and bound for a second location based on at least the location information of the second location in the case where the storage unit stores the location information of respective locations; and a display mode for the route starting form the first location and bound for the second location based at least on the route information of the route in the case where the storage unit stores the route information.

### CROSS REFERENCE TO RELATED APPLICATIONS

This application is based upon and claims the benefit of priority from Japanese patent application No. 2024-207972, filed on Nov. 29, 2024, the disclosure of which is incorporated herein in its entirety by reference.

### BACKGROUND

The present disclosure relates to a display system.

Patent Literature 1 discloses a navigation apparatus for performing route guidance for a vehicle from its current location to its destination. The navigation apparatus displays a map from which entry-prohibited roads are eliminated (i.e., excluded from display). Alternatively, the navigation apparatus displays entry-prohibited roads in a different color from other roads, displays marks indicating entry-prohibited roads in an overlapping manner on the road markings, and flash-displays the entry-prohibited roads.

[Patent Literature 1] Japanese Unexamined Patent Application Publication No. 2005-345360

### SUMMARY

The related art does not take into account the width of each route or the information of the locations accessed by the moving body, and is therefore insufficient as a technique for displaying the traveling environment of the moving body.

The present disclosure has been made in view of the above background, and an object of the present disclosure is to provide a display system that facilitates grasping of the number of moving bodies that can travel along a route.

According to the present disclosure, a display system for displaying routes connecting a plurality of locations, includes:
a storage unit configured to store at least one of location information on the number of moving bodies accommodable at each location and route information on a width of each route; and
a determination unit configured to determine:
   a display mode of a route starting from a first location and bound for a second location based on at least the location information of the second location in the case where the storage unit stores the location information of the respective locations; and
   a display mode of the route starting from the first location and bound for the second location based on at least the route information of the route in the case where the storage unit stores the route information.

According to the present disclosure, it is possible to provide a display system which facilitates grasping of the number of moving bodies that can travel along the route.

The above and other objects, features and advantages of the present disclosure will become more fully understood from the detailed description given hereinbelow and the accompanying drawings.

### BRIEF DESCRIPTION OF DRAWINGS

FIG. 1 is a block diagram illustrating a configuration of a display system according to a first embodiment;

FIG. 2 is a schematic diagram illustrating the traveling environment of the moving body according to the first embodiment;

FIG. 3 is a schematic diagram illustrating the traveling environment of the moving body according to first embodiment; and

FIG. 4 is a flowchart illustrating an operation of the display system according to the first embodiment.

### DESCRIPTION OF EMBODIMENTS

### First Embodiment

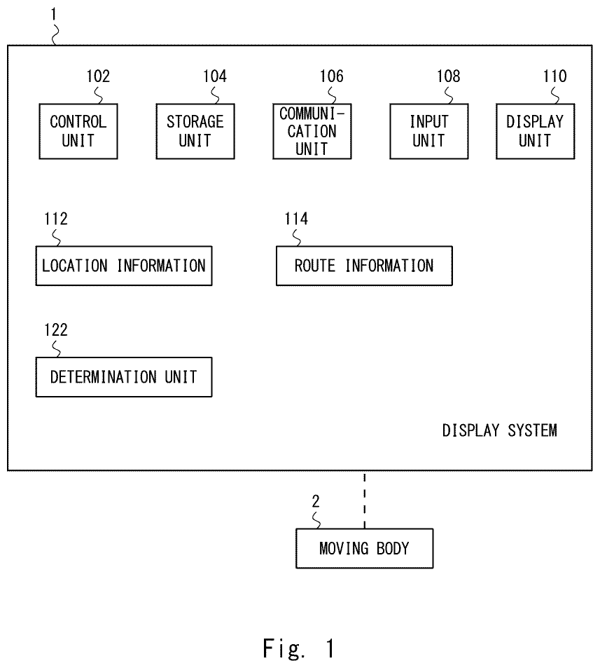

FIG. 1 is a block diagram illustrating a configuration of a display system 1 according to a first embodiment. The display system 1 may be wired or wirelessly connected to a moving body 2. The display system 1 may include the moving body 2. The display system 1 may be mounted on the moving body 2.

The display system 1 outputs display information in which a plurality of locations (also referred to as nodes) arranged in the traveling environment and a plurality of routes (also referred to as edges and sides) of the moving body 2 are displayed. Each route starts from a departure location (also referred to as a first location) and is bound for a destination location (also referred to as a second location). The departure location and the destination location are included in the plurality of locations. Each route has different departure location and destination location. For example, a user may set nodes and edges on a map illustrating the traveling environment of the moving body 2 via the GUI (Graphical User Interface) of the display system 1. The moving body 2 is an autonomous mobile robot equipped with sensors such as cameras, radars, and LIDAR (Light Detection and Ranging).

The display system 1 is, for example, a computer such as a server. The display system 1 can be realized by, for example, cloud computing. In this case, a plurality of structural elements/components of the display system 1 to be described later may be realized on physically different computers.

The display system 1 includes a control unit 102, a storage unit 104, a communication unit 106, an input unit 108, and a display unit 110 as main hardware configuration. The control unit 102, the storage unit 104, the communication unit 106, the input unit 108, and the display unit 110 are connected to each other via a data bus or the like. In the case where the display system 1 is realized by a plurality of computers, each of the plurality of computers may have the hardware configuration shown in FIG. 1.

The control unit 102 is a processor such as a CPU (Central Processing Unit), for example. The control unit 102 functions as a computation apparatus for performing control processing, arithmetic processing, and the like. The control unit 102 may include a plurality of processors.

The storage unit 104 is a storage device such as a memory or a hard disk, for example. The storage unit 104 is a ROM (Read Only Memory) or a RAM (Random Access Memory), for example. The storage unit 104 has a function for storing control programs and arithmetic programs to be executed by the control unit 102. That is, the storage unit 104 (a memory) has one or more instructions stored therein. The storage unit 104 also has a function for temporarily storing processing data or the like. The storage unit 104 may include a database. The storage unit 104 may include a plurality of memories.

The communication unit 106 performs processing necessary for communicating with other devices via a network. The communication unit 106 may include a communication port, a router, firewall, etc. The input unit 108 and the display unit 110 are, for example, GUIs. The input unit 108 is an input apparatus such as a keyboard, a touch panel, or a mouse. The display unit 110 is a display apparatus such as a display. The input unit 108 and the display unit 110 may be configured such that the input apparatus and the output apparatus are integrated, such as a touch panel, for example. The input unit 108 accepts an input operation of data performed by a user, and outputs information for the user to the display unit 110.

The storage unit 104 is configured to store at least one of location information 112 and route information 114. A plurality of locations and a plurality of routes are set on a map illustrating the traveling environment of the moving body 2. The locations or the routes may be set by the user through the input unit 108.

The location information 112 is information about the number of the moving bodies 2 that are accommodable at each location. For example, since the number of the moving bodies 2 accessible to a predetermined facility such as a charging facility or a delivery post is limited, there is an upper limit in the number of the moving bodies 2 accommodable at a location where the predetermined facility is installed. The location information 112 may be information indicating the number of the moving bodies 2 accommodable at each location. Alternatively, the location information 112 may be information indicating whether a predetermined facility is installed at each location. The route information 114 is information about the width of each route.

The display system 1 includes a determination unit 122 as a structural element/component thereof. Each structural element/component can be realized by executing programs under the control of the control unit 102, for example. More specifically, each structural element/component may be realized by the control unit 102 executing programs (instructions) stored in the storage unit 104. Further, each structural element/component may be realized by recording necessary programs in any nonvolatile storage medium and installing the programs as needed. Further, each structural element/component may be realized by any combination of hardware, firmware, and software, and may not limited to realization by program software. Further, each structural element/component may be realized by using an integrated circuit that can be programmed by a user, such as an FPGA (field-programmable gate array) or a microcomputer. In this case, the integrated circuit may be used to realize a program configured of the above-described structural elements/components.

The determination unit 122 is configured to determine the display mode of a route starting from the departure location and bound for the destination location based on at least one of the location information 112 and the route information 114. The display mode of a route may be, for example, the display color of a line representing a route (e.g., blue, yellow, red), the type of the line representing a route (e.g., dotted line, solid line, dash-dot line), or the number of lines representing routes.

A method of determining a display mode of a route based on the location information 112 will be described concretely. A plurality of locations in the traveling environment of the moving body 2 include an accommodation-restricted location. There is an upper limit in the number of the moving bodies 2 that are accommodable at the accommodation-restricted location. For example, a predetermined facility is installed at the accommodation-restricted location. The number of the moving bodies 2 that are accommodable at an accommodation-restricted location may be limited by the presence of obstacles in the neighborhood of the accommodation-restricted location.

There is an upper limit in the number of the moving bodies 2 that are accessible to the predetermined facility. The predetermined facility may be, for example, an elevator cabin doorway, a delivery-charging facility, a waiting area for the moving body 2, a delivery box, a delivery post, or an automatic door. The number of the moving bodies 2 that are accessible to the predetermined facility may be one. In addition, a plurality of locations in the traveling environment of the moving body 2 may include a location where a predetermined facility is not installed (also referred to as a non-accommodation-restricted location), for example, a location on a passage. A passage may be a place where the moving body 2 can travel through. For example, in the case where a predetermined facility is not installed at the destination of a route, the determination unit 122 sets the display color of the line representing the route in which the aforementioned predetermined facility is not installed at the destination thereof to yellow. For example, in the case where a predetermined facility is not installed at the destination of a route, the determination unit 122 sets the display color of the line representing the route in which the aforementioned predetermined facility is not installed at the destination thereof to blue.

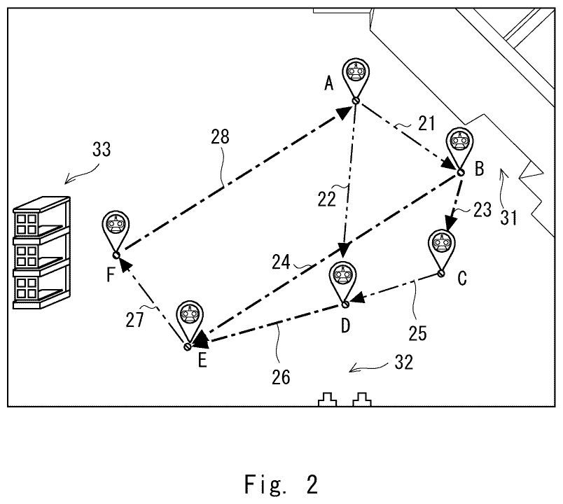

FIG. 2 illustrates the traveling environment of the moving body 2. In FIG. 2, a plurality of locations A to F and a plurality of routes 21 to 28 are set. The route 21 is a route starting from the location A and bound for the location B. The route 22 is a route starting from the location A and bound for the location D. The route 23 is a route starting from the location B and bound for the location C. The route 24 is a route starting from the location B and bound for the location E. The route 25 is a route starting from the location C and bound for the location D. The route 26 is a route starting from the location D and bound for the location E. The route 27 is a route starting from the location E and bound for the location F. The route 28 is a route starting from the location F and bound for the location A.

There are predetermined facilities at the locations B, D, and F. There is an elevator doorway 31 at the location B. There is a charging facility 32 at the location D. There is a delivery post 33 at the location F. The routes 21, 22, 25, and 27 bound for the locations B, D, or F are represented by double-dashed lines. The locations A, C, and E are non-accommodation-restricted locations. The routes 23, 24, 26, and 28 bound for the locations A, C, or E are represented by dashed lines.

The determination unit 122 makes the display modes of the route 21, 22, 25, and 27 different from the display modes of the routes 23, 24, 26, and 28. For example, the determination unit 122 sets the display color of the lines representing the route 21, 22, 25, and 27 to yellow, and sets the display color of the lines representing the routes 23, 24, and 26 to blue.

The display mode of a route may correspond to the number of the moving bodies 2 that can be accommodated at the destination of the route, for example, the number of the moving bodies 2 accessible to a predetermined facility installed at the destination of the route. Therefore, the determination unit 122 may make the display mode of a route bound for a destination where one moving body 2 can be accommodated different from the display mode of a route bound for a destination where two moving bodies 2 can be accommodated. The determination unit 122 may set the display color of the lines representing the route bound for the destination where two moving bodies 2 can be accommodated, for example, to a color other than yellow and blue. For example, the determination unit 122 may indicate a route bound for a destination where two moving bodies 2 can be accommodated by two lines and set the display color of the two lines to yellow.

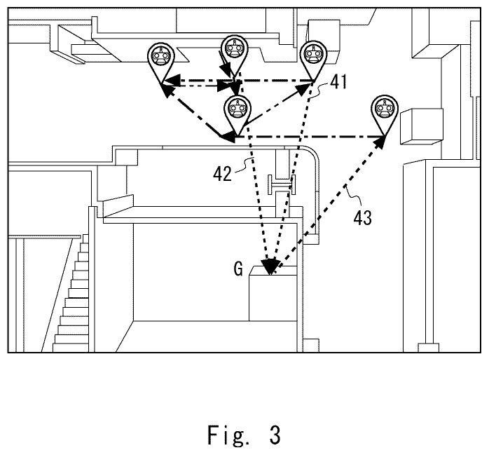

Referring to FIG. 3, there is a location G where the moving body 2 cannot be accommodated (also referred to as a non-accommodable location). In other words, the location G is a location where the moving body 2 cannot access, and can be said to be a location that is deemed not to exist along the passage. The route 41 and the route 42 are routes bound for the location G. The determination unit 122 sets the display mode of the route 41 and the route 42 to a specific display mode. The determination unit 122 sets the display color of the lines representing the route 41 and the route 42 to red, for example. The departure location of the route 43 is set at the location G. The route 43 is also represented by a dotted line. The determination unit 122 may also set the display color of the line representing the route 43 to red. The user can visually recognize the route displayed in a specific display color and intuitively understand that there is an error in the setting of the node (the location).

Referring again to FIG. 1, the determination unit 122 may determine the display mode of each route based on the route information. Depending on the width of each route, the number of the moving bodies 2 that can simultaneously travel along the route may be limited. The determination unit 122 is configured to calculate the number of the moving bodies 2 that can simultaneously travel along the route based on the width of each route and the size of the respective moving bodies 2. In the case where the number of the moving bodies 2 that can simultaneously travel along the first route is different from the number of the moving bodies 2 that can simultaneously travel along the second route, the determination unit 122 may make the display mode of the first route and the display mode of the second route different from each other. In other words, the display mode of a route may correspond to the number of the moving bodies 2 that can simultaneously travel along route.

The determination unit 122 may set the traveling route based on both the location information 112 and the route information 114. The determination unit 122 may determine the display mode for a route based on the smaller one of the number of the moving bodies 2 that can be accommodated at the destination location of the route and the number of the moving bodies 2 that can simultaneously travel along the route.

After the locations and the route are set by the user, the display system 1 may set three-dimensional coordinates for each location and output setting information including three-dimensional information of each location to the moving body 2. The moving body 2 travels autonomously based on the setting information. The setting information may include information indicating constraints on the number of the moving bodies 2 that are accommodable at each location and the number of the moving bodies 2 that can simultaneously travel along each route. The moving body 2 may use a sensor to determine the locations of the other the moving bodies 2 or the route along which the other the moving bodies 2 are traveling, and travel autonomously so as to satisfy the constraints.

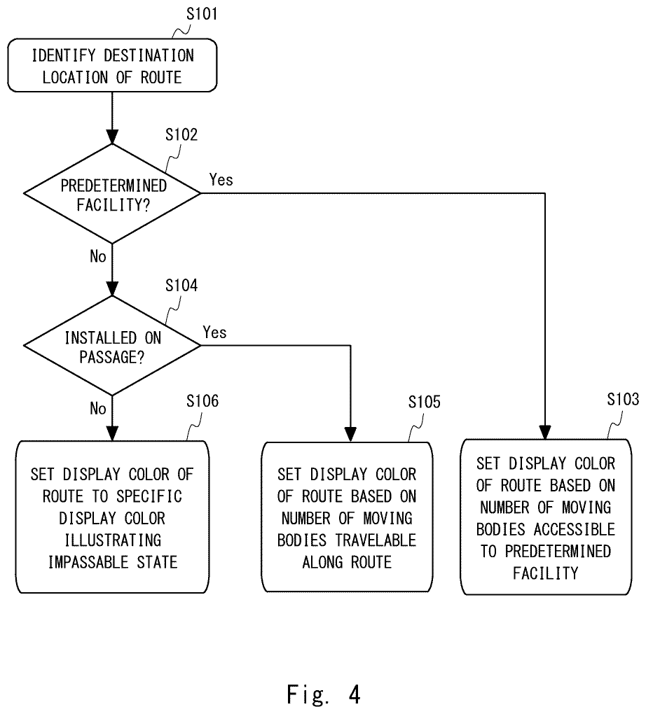

FIG. 4 is a flowchart illustrating the operation of the display system 1. First, the determination unit 122 identifies the destination location of a route where the display color is to be set (Step S101), and determines whether a predetermined facility is installed at the destination location of the route (Step S102). In the case where a predetermined facility is installed at the destination location of the route (Step S102: YES), the determination unit 122 sets the display color of the route based on the number of the moving bodies 2 accessible to the predetermined facility (Step S103). In the case where there is no predetermined facility installed at the destination location of the route (Step S102: NO), the determination unit 122 determines whether or not there is the destination location of the route along the passage (Step S104). In the case where there is the destination location of the route along the passage (Step S104: YES), the determination unit 122 determines the display color of the route based on the number of the moving bodies 2 that can simultaneously travel along the route (Step S105). In the case where there is no destination location of the route along the passage (Step S104: NO), the determination unit 122 sets the display color of the route to a specific display color (e.g., red) indicating that the route is impassable (Step S106).

In the first embodiment, each route existing in the traveling environment of the moving body 2 is displayed in a display mode corresponding to the number of the moving bodies 2 which can simultaneously travel along the route and the number of the moving bodies 2 which are accessible to a predetermined facility provided at the destination of the route. Therefore, in the first embodiment, it is possible to facilitate grasping of the number of the moving bodies 2 that can travel along a route.

It should be noted that the present disclosure is not limited to the above-described embodiment, and may be modified as appropriate without departing from the gist of the present disclosure. Further, a part or all of the processing in the control unit 102 can be realized by making a processor such as a CPU (Central Processing Unit) execute a computer program. For example, the control unit 102 can be implemented as a device capable of executing a program, such as a central processing unit of a computer. Various functions can also be realized by a program.

The above-described program includes a group of instructions (or software code) for making the computer perform one or more functions when read into the computer. The program may be stored on a non-temporary computer-readable medium or a tangible storage medium. By way of example and not limitation, the computer-readable medium or a physical storage medium includes random-access memory (RAM), read-only memory (ROM), flash memory, solid-state drive (SSD) or other memory technology, CD-ROM, digital versatile disc (DVD), Blu-ray (registered trademark) disc or other optical disk storage, magnetic cassette, magnetic tape, magnetic disk storage or other magnetic storage device. The program may be transmitted on a temporary computer-readable medium or a communication medium. By way of example and not limitation, the temporary computer-readable medium or a communication medium includes an electrical, optical, acoustic or other form of propagation signal.

It should be noted that the present disclosure is not limited to the above embodiments and may be modified as appropriate without departing from the purport.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A display system for displaying routes connecting a plurality of locations, comprising:
a storage unit configured to store at least one of location information on the number of moving bodies accommodable at each location and route information on a width of each route; and
a determination unit configured to determine:
a display mode of a route starting from a first location and bound for a second location based on at least the location information of the second location in the case where the storage unit stores the location information of the respective locations; and
a display mode of the route starting from the first location and bound for the second location based on at least the route information of the route in the case where the storage unit stores the route information.

2. The display system according to claim 1, wherein
the determination unit makes a display mode of the route bound for the second location where a predetermined facility is installed, different from a display mode of the route bound for the second location where the predetermined facility is not installed,
the predetermined facility is any one of an elevator cabin doorway, a delivery-charging facility, a waiting area for the moving body, a delivery box, a delivery post, and an automatic door.

3. The display system according to claim 1, wherein the display mode corresponds to the number of the moving bodies that can simultaneously travel along the route.

4. The display system according to claim 1, wherein the display mode corresponds to the number of the moving bodies that are accommodable at the second location.

5. The display system according to claim 1, wherein the determination unit sets the display mode of the route bound for the second location at which the moving body cannot be accommodated to a specific display mode.
